(19) United States
(12) Patent Application Publication
(10) Pub. No.: US 2012/0298496 A1
(43) Pub. Date: Nov. 29, 2012

(54) PRESS KEY AND KEYBOARD

(75) Inventor: QING ZHANG, Changshu (CN)

(73) Assignee: Changshu Sunrex Technology Co., Ltd.

(21) Appl. No.: 13/116,633

(22) Filed: May 26, 2011

(51) Int. Cl. H01H 13/76; H01H 13/02

(52) U.S. Cl. 200/5 A; 200/344

(57) ABSTRACT

A press key includes: a keycap made of metal; a base board; a circuit board disposed on the base board; an insulating film disposed on the circuit board; and an elastic member disposed between the insulating film and the keycap, the elastic member being pressed toward the circuit board when the keycap is pressed, and being resilient to return the keycap to an original position when the keycap is released. A keyboard including a plurality of the aforesaid press keys is also disclosed.

### BACKGROUND OF THE INVENTION

1. Field of the Invention

This invention relates to a press key and a keyboard including a plurality of the press keys, more particularly to a press key having a keycap made of metal and a keyboard including a plurality of the press keys.

2. Description of the Related Art

Referring to FIGS. 1 to 3, a conventional press key 1 comprises a base board 11, a keycap 12, a circuit board 13 disposed on the base board 11, an insulating film 14 disposed on the circuit board 13, an elastic member 15 disposed between the keycap 12 and the insulating film 14, and a linkage assembly 16 supporting the keycap 12 for upward and downward movement relative to the base board 11. The elastic member 15 is pressed toward the circuit board 13 to produce a press signal when the keycap 12 is pressed, and is resilient to return the keycap 12 to an original position when the keycap 12 is released. However, the keycap 12 is made of plastic, and will not provide a sufficient strength if the thickness thereof is decreased. Therefore, it is hard to reduce the weight and height of the keycap 12 and the press key 1, and an electronic product including the press key 1 has relatively large height and weight.

### SUMMARY OF THE INVENTION

Therefore, an object of the present invention is to provide a press key and a keyboard that can overcome the aforesaid drawbacks associated with the prior art.

According to the first aspect of this invention, a press key comprises:

a keycap made of metal;

a base board;

a circuit board disposed on the base board;

an insulating film disposed on the circuit board; and

an elastic member disposed between the insulating film and the keycap, the elastic member being pressed toward the circuit board when the keycap is pressed, and being resilient to return the keycap to an original position when the keycap is released.

According to the second aspect of this invention, a keyboard comprises a housing and a plurality of press keys assembled to the housing, each of the press keys including:

a keycap made of metal;

a base board;

a circuit board disposed on the base board;

an insulating film disposed on the circuit board; and

an elastic member disposed between the insulating film and the keycap, the elastic member being pressed toward the circuit board when the keycap is pressed, and being resilient to return the keycap to an original position when the keycap is released.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded view of a conventional press key;

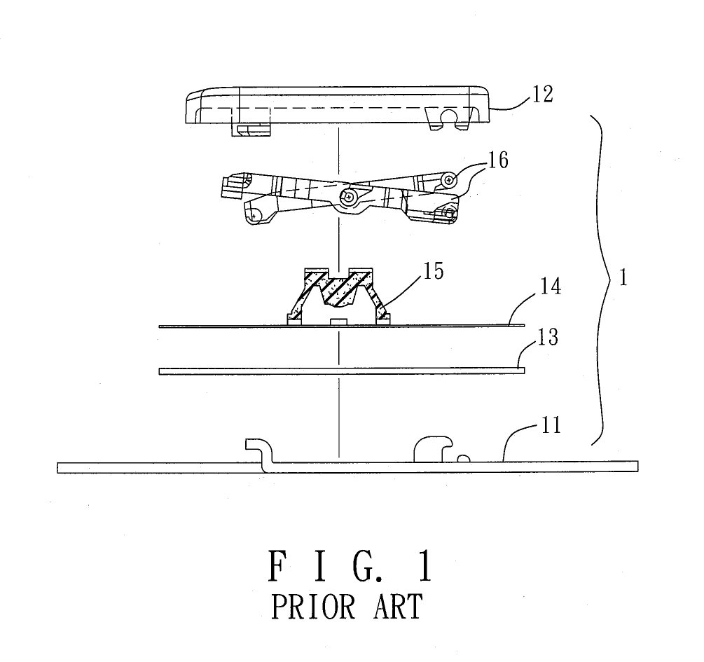

FIG. 2 is a side view of the press key of FIG. 1 in an assembled state;

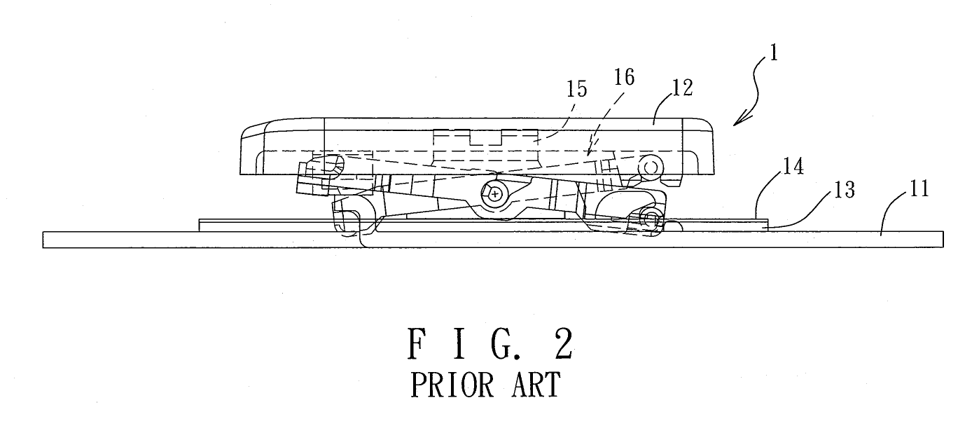

FIG. 3 is a bottom perspective view of a conventional keycap shown in FIG. 1;

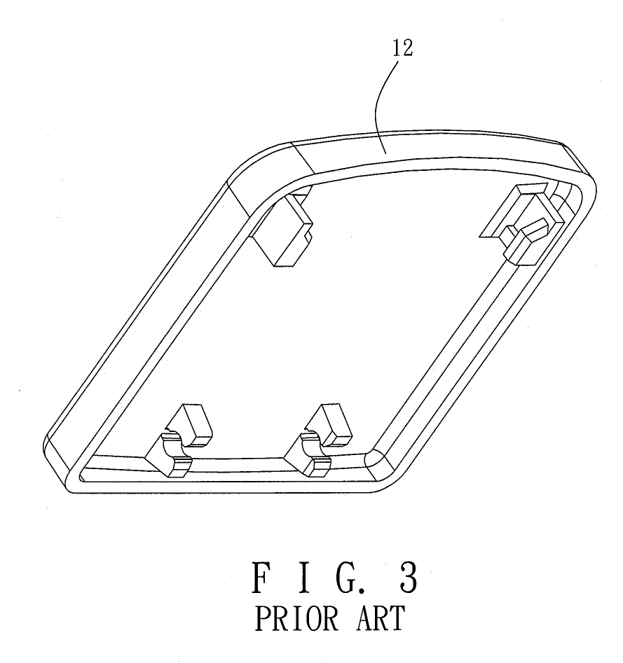

FIG. 4 is a perspective view of the preferred embodiment of a keyboard according to this invention;

FIG. 5 is an exploded view of the preferred embodiment of a press key shown in FIG. 4;

FIG. 6 is a side view of the press key of FIG. 5 in an assembled state; and

FIG. 7 is a bottom perspective view of a keycap shown in FIG. 5.

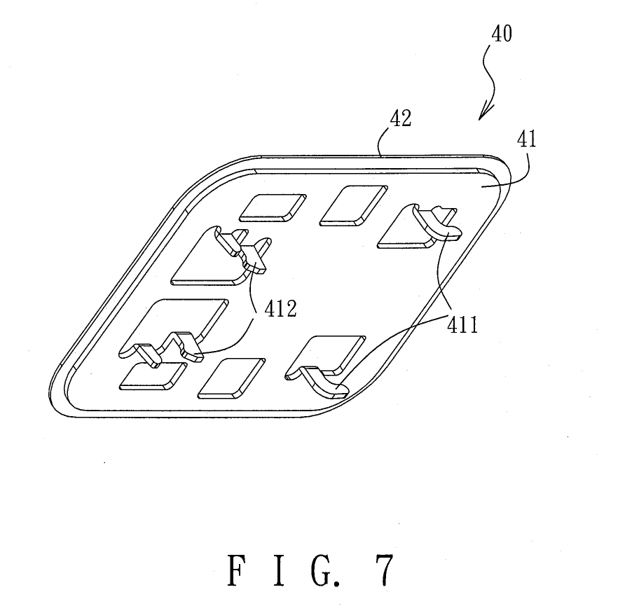

### DETAILED DESCRIPTION OF THE PREFERRED EMBODIMENT

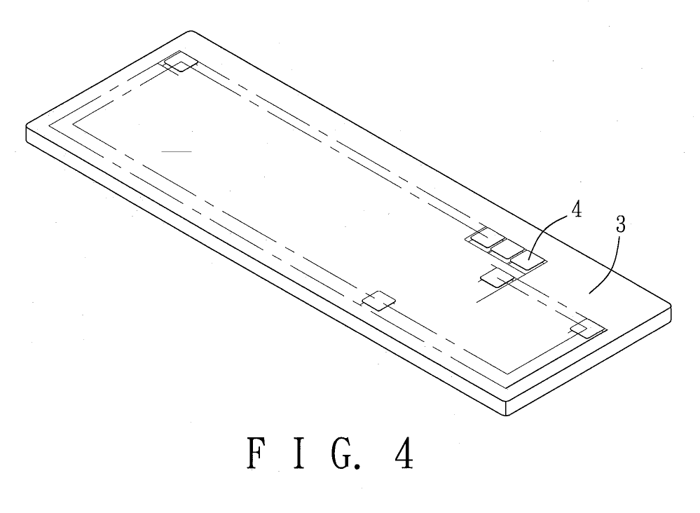

Referring to FIG. 4, the preferred embodiment of a keyboard according to this invention comprises a housing 3 and a plurality of press keys 4. Each of the press keys 4 is assembled to the housing 3 and is adapted to be pressed to input information.

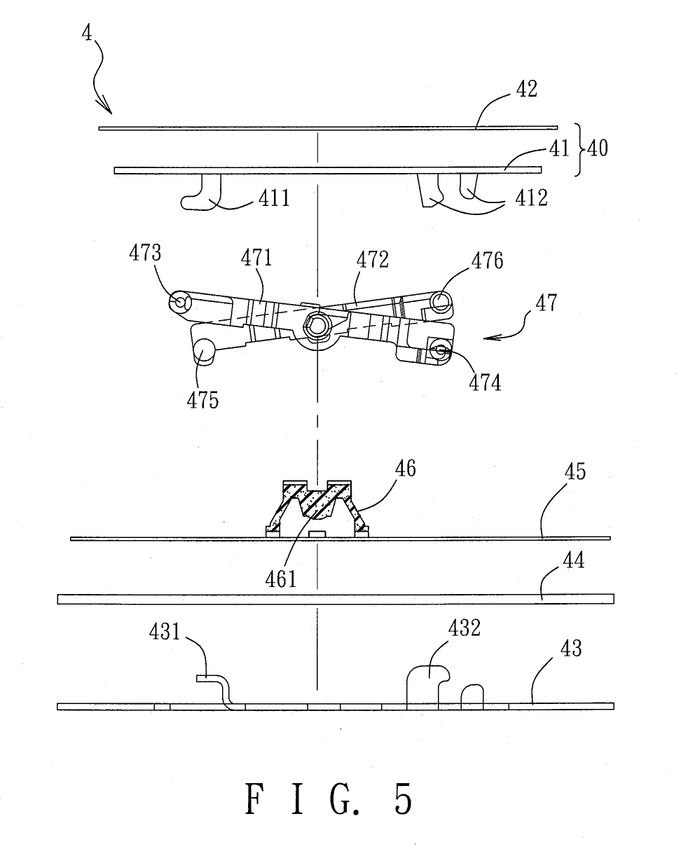

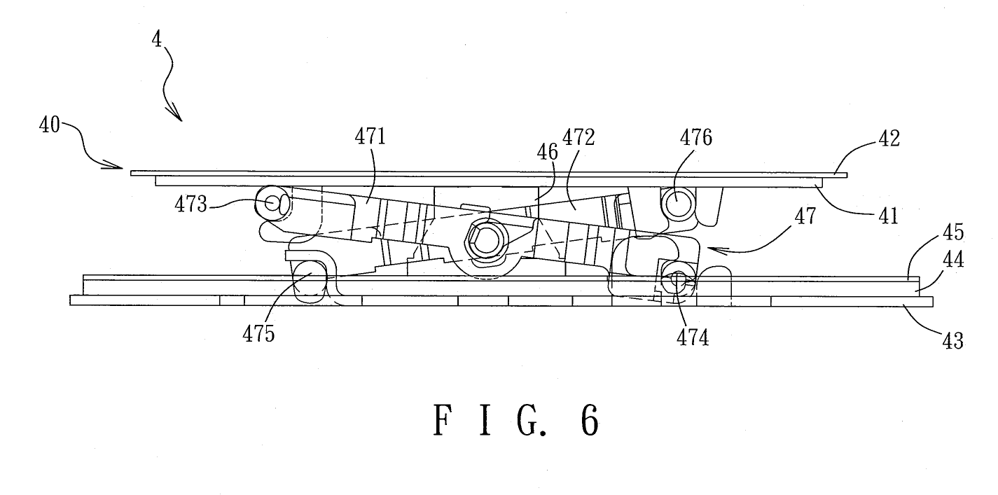

Referring FIGS. 5 and 6, each of the press keys 4 includes: a keycap 40 made of metal; a base board 43; a circuit board 44 disposed on the base board 43; an insulating film 45 disposed on the circuit board 44; an elastic member 46 disposed between the insulating film 45 and the keycap 40; and a scissors-type linkage assembly 47 connected between the base board 43 and the keycap 40. The elastic member 46 is pressed toward the circuit board 44 when the keycap 40 is pressed, and is resilient to return the keycap 40 to an original position when the keycap 40 is released. The keycap 40 includes a stamped metal plate 41 disposed on top of the scissors-type linkage assembly 47, and a top plate 42 fixed to a top of the stamped metal plate 41. The stamped metal plate 41 is slit to form a plurality of strip portions which are bent downward to form a plurality connecting elements 411, 412 that project downward. The scissors-type linkage assembly 47 is connected movably to the connecting elements 411, 412.

In this embodiment, the top plate 42 is fixed to the top of the stamped metal plate 41 using a solder or a glue. Alternatively, the keycap 40 may have a one-piece structure that has downwardly projecting connecting elements 411, 412 to be connected-to the scissors-type linkage assembly 47. Preferably, the stamped metal plate 41 and the top plate 42 are made of an aluminum alloy or an aluminum magnesium alloy.

The base board 43 has a plurality connecting elements 431, 432 formed thereon. The circuit board 44 is a thin film circuit board and is formed with a switch (not shown) such as a membrane switch or other touch-sensitive switch. The insulating film 45 is made of a mylar film or other insulating material. The elastic member 46 is, but not limited to, a rubber dome. The elastic member 46 has a contact 461 protruding downwardly from a center portion of the elastic member 46. When the keycap 40 is pressed to compress the elastic member 46, the contact 461 of the elastic member 46 is pressed to contact the switch on the circuit board 44 to generate a keying signal.

The scissors-type linkage assembly 47 includes first and second levers 471, 472 each being in a form of a rectangular frame. The first lever 471 has an upper end 473 connected movably to the connecting elements 411, and a lower end 474 connected pivotally to the connecting elements 432. The second lever 472 is connected pivotally to the first lever 471, and has a lower end 475 connected movably to the connecting elements 431, and an upper end 476 connected pivotally to the connecting elements 412. Therefore, when the top plate 42 of the keycap 40 is pressed, the stamped metal plate 41 and the scissors-type linkage assembly 47 move toward the base board 43.

Because the strength of a metal is higher than that of a plastic having the same thickness as the metal, the keycap 40 made of metal according to this invention can be thinner and lighter than the conventional plastic keycap. Accordingly, the press key 4 and the keyboard of this invention have a light-weight and thin structure.

Besides, a top surface of the top plate 42 can be formed with a pattern or special metallic luster by electroplating or wire-drawing process.

Furthermore, although the press key 4 is assembled to the housing 3 in this embodiment, the press key 4 can also be used singly.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A press key, comprising:
a keycap made of metal;
a base board;
a circuit board disposed on said base board;
an insulating film disposed on said circuit board; and
an elastic member disposed between said insulating film and said keycap, said elastic member being pressed toward said circuit board when said keycap is pressed, and being resilient to return said keycap to an original position when said keycap is released.

2. The press key of claim 1, further comprising a scissors-type linkage assembly connected between said base board and said keycap, said keycap having a plurality of connecting elements projecting downward for connection with said scissors-type linkage assembly.

3. The press key of claim 2, wherein said keycap includes a stamped metal plate disposed on top of said scissors-type linkage assembly, and a top plate fixed to a top of said stamped metal plate, said stamped metal plate being slit to forma plurality of strip portions, which are bent downward to form said connecting elements.

4. The press key of claim 3, wherein said top plate is fixed to the top of said stamped metal plate using a solder or a glue.

5. The press key of claim 2, wherein said keycap has a one-piece structure.

6. A keyboard comprising a housing and a plurality of press keys assembled to said housing, each of said press, keys including:
a keycap made of metal;
a base board;
a circuit board disposed on said base board;
an insulating film disposed on said circuit board; and
an elastic member disposed between said insulating film and said keycap, said elastic member being pressed toward said circuit board when said keycap is pressed, and being resilient to return said keycap to an original position when said keycap is released.

7. The keyboard of claim 6, wherein each of said press keys further includes a scissors-type linkage assembly connected between said base board and said keycap, said keycap having a plurality of connecting elements projecting downward for connection with said scissors-type linkage assembly.

8. The keyboard of claim 7, wherein said keycap includes a stamped metal plate disposed on top of said scissors-type linkage assembly, and a top plate fixed to a top of said stamped metal plate, said stamped metal plate being slit to form a plurality of strip portions, which are bent downward to form said connecting elements.

9. The keyboard of claim 8, wherein said top plate is fixed to the top of said stamped metal plate using a solder or a glue.

10. The keyboard of claim 7, wherein said keycap has a one-piece structure.
